(19) United States
(12) Patent Application Publication
(10) Pub. No.: US 2024/0177342 A1
(43) Pub. Date: May 30, 2024

(54) INFORMATION PROCESSING DEVICE, INFORMATION PROCESSING METHOD, AND STORAGE MEDIUM

(71) Applicant: CANON KABUSHIKI KAISHA, Tokyo (JP)

(72) Inventor: TAKASHI ADACHI, Saitama (JP)

(21) Appl. No.: 18/507,225

(22) Filed: Nov. 13, 2023

(30) Foreign Application Priority Data
Nov. 30, 2022 (JP) 2022-191430

(51) Int. Cl. G06T 7/73; G01C 21/00; G06V 10/776; G06V 20/50

(52) U.S. Cl. CPC G06T 7/73; G01C 21/3837; G06V 10/776; G06V 20/50

(57) ABSTRACT

An information processing device that can notify of information on an object affecting accuracy in self-position estimation includes: a self-position estimating unit configured to estimate a self-position on the basis of an image; an accuracy determining unit configured to determine accuracy in estimation of the self-position; an image analyzing unit configured to detect an object from the image; and a notification unit configured to notify of information on the object detected by the image analyzing unit in a case in which the accuracy is outside of a predetermined range.

### BACKGROUND OF THE INVENTION

### Field of the Invention

The present invention relates to an information processing device, an information processing method, and a storage medium for estimating a self-position.

### Description of the Related Art

For example, when a self-propelled robot or the like moves in an environment such as a factory, a method of controlling an amount of movement on the basis of a self-position estimated from image information to stably perform movement control of a movable apparatus is known as described in Japanese Unexamined Patent Application Publication No. 2019-125345. Japanese Patent No. 6723798 discloses a technique of providing information for assisting with calculation accuracy of a self-position based on features in an image captured by an imaging device.

However, in such a related art, there is a problem in that it is difficult to ascertain a factor when accuracy of self-position estimation changes.

### SUMMARY OF THE INVENTION

According to one aspect of the present invention, there is provided an information processing device including at least one processor or circuit configured to function as: a self-position estimating unit configured to estimate a self-position on the basis of an image; an accuracy determining unit configured to determine accuracy in estimation of the self-position; an image analyzing unit configured to detect an object from the image; and a notification unit configured to notify of information on the object detected by the image analyzing unit in a case in which the accuracy is outside of a predetermined range.

Further features of the present invention will become apparent from the following description of embodiments with reference to the attached drawings.

### BRIEF DESCRIPTION OF THE DRAWINGS

FIG. 1 is a diagram illustrating a system configuration according to an embodiment of the present invention.

FIG. 2 is a functional block diagram illustrating an example of a configuration of an information processing device according to the embodiment of the present invention.

FIG. 3 is a flowchart illustrating an example of a process flow of the information processing device according to the embodiment of the present invention.

FIG. 4 is a diagram illustrating an example in which a result of image analysis is displayed according to the embodiment of the present invention.

FIG. 5 is a diagram illustrating an example in which a result of image analysis is displayed on a map according to the embodiment of the present invention.

FIG. 6 is a block diagram illustrating an example of a hardware configuration of the information processing device according to the embodiment of the present invention.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

In the present embodiment, movement control of a movable apparatuse such as an automated guided vehicle (AGV) or an autonomous mobile robot (AMR), particularly, a route setting method in autonomous traveling, will be described.

In the following description, an AGV is exemplified as a movable apparatus, but the movable apparatus may be an AMR or a service mobile robot (SMR).

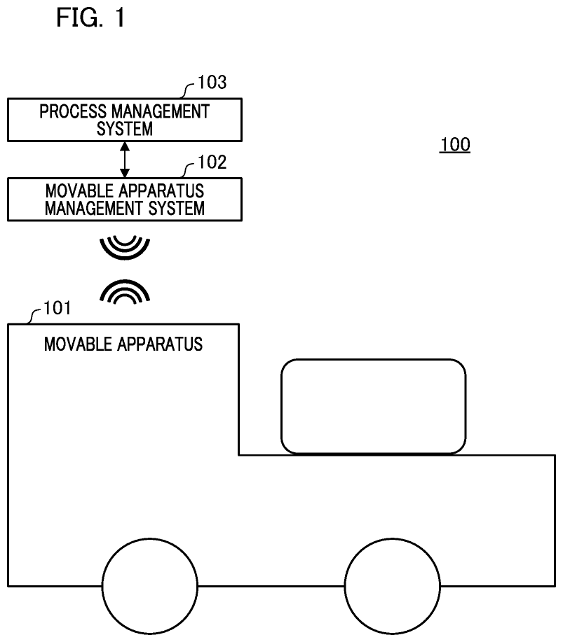

FIG. 1 is a diagram illustrating a system configuration according to an embodiment of the present invention. An information management system 100 according to the present embodiment includes a plurality of movable apparatuses 101 (101-1, 101-2, . . . ), a process management system 103, and a movable apparatus management system 102. The information management system 100 is a physical distribution system, a production system, or the like.

The plurality of movable apparatuses 101 (101-1, 101-2, . . . ) are transportation vehicles (AGVs) that transport objects according to a schedule of processes determined by the process management system 103. A plurality of movable apparatuses move (travel) in an environment.

The process management system 103 manages processes which are performed by the information management system 100. For example, the process management system 103 is a manufacturing execution system (MES) that manages processes in a factory or a physical distribution warehouse. The process management system 103 communicates with the movable apparatus management system 102.

The movable apparatus management system 102 is a system that manages movable apparatuses and communicates with the process management system 103. The movable apparatus management system 102 also performs communication (for example, Wi-Fi communication) with the movable apparatuses 101 and transmits and receives operation information interactively.

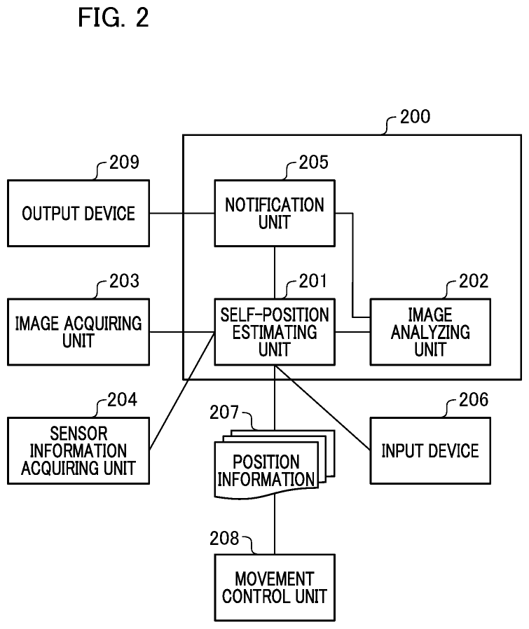

FIG. 2 is a functional block diagram illustrating an example of a configuration of an information processing device according to the embodiment of the present invention. Some of the functional blocks illustrated in FIG. 2 are realized by causing a CPU or the like serving as a computer included in the information processing device to execute a computer program stored in a memory which is a storage medium.

However, some or all thereof may be realized by hardware. A dedicated circuit (ASIC), a processor (a reconfigurable processor or a DSP), or the like can be used as hardware. The functional blocks illustrated in FIG. 2 may not be incorporated into the same housing and may be constituted by different devices connected to each other via a signal path.

An information processing device 200 includes a self-position estimating unit 201, an image analyzing unit 202, and a notification unit 205. The information processing device 200 is connected to an image acquiring unit 203 configured to acquire an image from an imaging device such as a camera and a sensor information acquiring unit 204 configured to acquire information from a range sensor, an acceleration sensor, or an infrared sensor.

The information processing device 200 is connected to an input device 206 that receives a user operation such as a mouse, a keyboard, or a touch panel and an output device 209 that outputs notification details.

A movement control unit 208 acquires position information 207 from the self-position estimating unit 201 and controls the movable apparatuses. The information processing device 200 can be mounted in a movable apparatus 101. The information processing device 200 may be a device that communicates with the movable apparatus 101 via a network I/F 603 which will be described later through Wi-Fi or the like.

When data is received from the outside, the information processing device 200 is physically connected to the outside via a bus or the like or uses the network I/F 603. The self-position estimating unit 201 has a configuration of simultaneous localization and mapping (SLAM) for preparing a map on the basis of an image acquired by the image acquiring unit 203 and estimating a self-position. Here, the self-position estimating unit 201 estimates a self-position on the basis of an image.

Many SLAM methods have been proposed and can be used. For example, a method of storing feature quantities acquired using an algorithm such as SIFT or ORB from images acquired from a plurality of different viewpoints as a key frame and estimating a self-position by matching may be used.

SIFT is an abbreviation for “scale-invariant feature transform,” and ORB is an abbreviation for “oriented FAST and rotated BRIEF.” Alternatively, a method of comparing luminance values of images captured from a plurality of different viewpoints and estimating a self-position such that an error is minimized may be used.

In addition, an RBG-D SLAM algorithm of generating a map while tracking using depths of feature points detected from an RBG image as depth values of a depth sensor is also known and may be used. A position estimation method using a method based on deep learning may be used.

The image analyzing unit 202 collects feature quantities (Haar-Like features, Histograms of Oriented Gradients (HOG) features, and the like) of training images and performs learning using a discriminator such as a discrimination instrument. A result of learning is stored as a detector dictionary and used at the time of detection. A likelihood of detection is calculated as a detection score. For example, a weighted sum of outputs can be output as a detection score.

An output with a higher likelihood of a target object to be detected by each detector is assumed to be obtained as the detection score becomes higher. An example of a method of detecting a person is a method of extracting local feature quantities using sample images of persons and detecting a person using a discriminator trained using a statistical learning method. A method of detecting and counting persons is not limited to the aforementioned algorithms, and any algorithm may be used.

When the AGV includes an inertial sensor such as a gyro sensor or an inertial measurement unit or a sensor such as an encoder acquiring an amount of a tire, the sensor information acquiring unit 204 outputs a sensor value thereof. The self-position estimating unit 201 may calculate the self-position of the image acquiring unit 203 using an image and the sensor value together.

By using image information from the image acquiring unit 203 and sensor information together in this way, it is possible to calculate a self-position robustly with high accuracy.

The accuracy of the SLAM is not limited to the aforementioned calculation as long as it can be calculated using features, scores, or the like which can be acquired through an algorithm or the like.

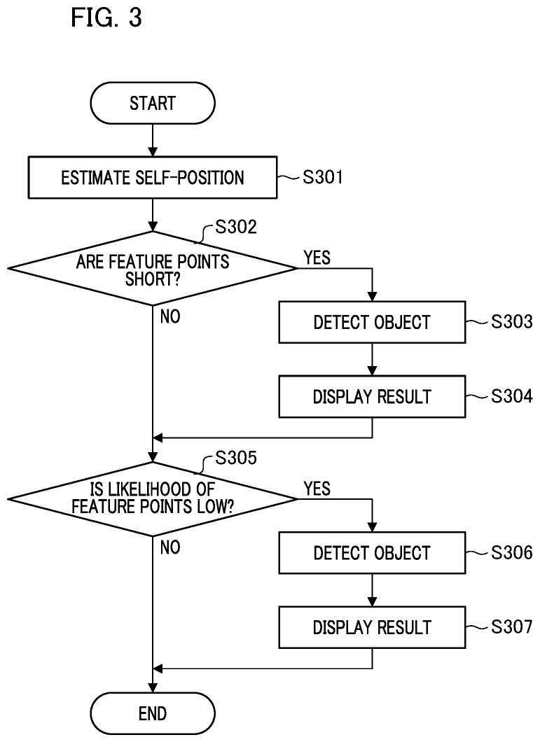

FIG. 3 is a flowchart illustrating an example of a process flow which is performed by the information processing device according to the embodiment of the present invention. Operations of steps in the flowchart of FIG. 3 are performed by causing a CPU or the like serving as a computer in the information processing device to execute a computer program stored in the memory.

In Step S301 (a self-position estimating step), the self-position estimating unit 201 acquires an image from the image acquiring unit 203 and estimates a self-position on the basis of the image. Then, in Step S302, it is determined whether the number of feature points in estimation of a self-position is short. That is, when the number of feature points in estimation of a self-position is equal to or less than a predetermined number, it is determined that accuracy of self-position estimation is lower than a predetermined range.

For example, when the number of feature points included in the image is less than a first threshold value (predetermined value) which is set to, for example, 200, that is, when the determination result of Step S302 is YES, the process flow proceeds to Step S303. In Step S303, image analysis is performed to detect an object.

In Step S302, the image may be partitioned into a plurality of areas and whether a feature point is included in each area may be used as a determination reference. As a method of partitioning the image, the image may be partitioned in a lattice shape or in a concentric circle shape, and the partitioning shape is not particularly limited. By partitioning the image and performing the determination, when the number of feature points in the image is short even in a case in which feature points are locally present, it is determined that objects with less features such as walls or luggage occupy most of the image.

Accordingly, image analysis is performed to detect an object in Step S303, and information on the object detected in Step S303 is displayed and a message indicating that the less number of feature points is a factor of a decrease in accuracy is displayed (notified) to a user in Step S304.

A display device for display (notification) may be provided in the information processing device 200, or an external display device (the output device 209) may be used. The notification unit 205 notifies of notification (display) details. The input device 206 may serve as an input/output device such as a tablet.

Then, in Step S305, it is determined whether a likelihood of feature points is lower than a predetermined second threshold value. For example, an example in which accuracy is normalized in 100 steps will be described below. When the second threshold value determined arbitrarily is set to 40 and the accuracy is less than 40 which is the second threshold value, the determination result of Step S305 is YES, and the process flow proceeds to Step S306.

Here, Steps S302 and S305 serve as an accuracy determining process (an accuracy determining unit) of determining accuracy in estimation of a self-position. Steps S303 and S306 serve as an image analyzing step (an image analyzing unit) of detecting an object from an image.

Steps S304 and S307 serve as a notification step (a notification unit) of notifying of information on an object detected through the image analyzing step when the accuracy of self-position estimation is outside of a predetermined range.

In step S306, image analysis is performed to detect an object. In Step S307, information on the object detected in Step S306 is displayed and a message indicating that the lower likelihood of feature points is a factor of a decrease in accuracy is displayed (notified) to a user.

As described above, a display device for display (notification) may be provided in the information processing device 200, or an external display device (the output device 209) may be used. The notification unit 205 notifies of notification (display) details. The input device 206 may serve as an input/output device such as a tablet.

In this way, in the present embodiment, it is determined in Step S305 whether the likelihood of feature points is lower than a predetermined threshold value. That is, when the likelihood of feature points in estimation of a self-position is equal to or less than the predetermined threshold value, it is determined that the accuracy is lower than the predetermined range. When the determination result of Step S305 is YES, it is possible to detect an object by performing image analysis and to display information on the object as a factor of a decrease in accuracy.

This timing may be combined with a next timing to reduce the number of times of analysis. For example, estimation of a self-position may be performed at a position close to a position at which a key frame in which feature quantities of a three-dimensional point group are recorded is present. Alternatively, the estimation of a self-position may be performed in combination with an arbitrary period such as a 1-second interval.

Accordingly, it is possible to reduce resources used for the information processing device by curbing frequent performing of image analysis. Since devices such as AGVs operates in an environment in which a battery or the like is limited, it is possible to enable operation in a long term by not performing unnecessary calculation.

In this way, when accuracy of self-position estimation (shortage of feature points or a likelihood of feature points) is low, information on the object detected through image analysis is displayed as a factor of a decrease in accuracy of self-position estimation. Accordingly, a user can take a countermeasure against the factor of a decrease in accuracy of self-position estimation on the basis of the displayed information.

On the contrary to the aforementioned description, when the number of feature points is greater than a third threshold value which is greater than the first threshold value or the likelihood of feature points is greater than a fourth threshold value which is greater than the second threshold value, it may be instructed to perform image analysis. That is, when the accuracy of self-position estimation is higher than a predetermined range, this may be notified of.

When a marker such as a poster or a tag is detected through image analysis, a user can ascertain that accuracy is improved by the poster, the tag, or the like by presenting the poster or the tag as a factor for improving a self-position.

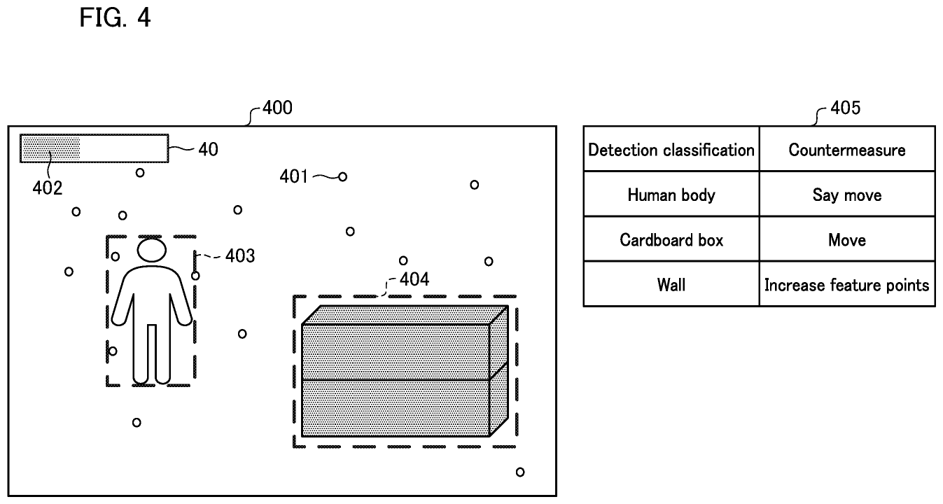

FIG. 4 is a diagram illustrating an example in which a result of image analysis is displayed according to the embodiment of the present invention. A display method of an image acquired by the image acquiring unit 203, a self-position calculated by the self-position estimating unit 201, and a detection result of an object detected by the image analyzing unit 202 will be described below with reference to FIG. 4. Details illustrated in FIG. 4 are displayed on the output device 209. As described above, the input device 206 may serve as an input/output device such as a tablet at that time.

401 denotes a feature point detected by the self-position estimating unit 201. 402 denotes a current accuracy value in self-position estimation by the self-position estimating unit 201. A human body 403 and a cardboard box 404 indicate a result detected by the image analyzing unit 202.

Countermeasures (instruction details) based on an object detected through image analysis are described in a countermeasure list 405. For example, when an object detected as a result of image analysis is a person (human body), an instruction such as “Self-position is being estimated” or “please move (because self-position is being estimated)” may be presented to the person by speech or image display.

Speech or an image is output from the output device 209. As described above, the input device 206 may serve as an input/output device such as a tablet at that time.

For example, when an object which is a stationary object such as a cardboard box and which is easy to move is detected through image analysis, it is necessary to determine whether to move and thus an instruction such as “please move (as needed)” may be presented by speech or image display. Speech or an image is output from the output device 209. As described above, the input device 206 may serve as an input/output device such as a tablet at that time.

When a place with less feature quantities such as a wall is detected through image analysis, an instruction such as “please increase feature points by marking (a poster or a tag)” may be presented by speech or image display.

That is, when the accuracy is lower than the predetermined range, a countermeasure for increasing the accuracy is notified of on the basis of the object detected by the image analyzing unit. In this way, by providing a storage unit storing notification details correlated with the detected object, storing the countermeasure list 405 in the storage unit, and presenting a countermeasure to a user, it is possible to improve accuracy of self-position estimation.

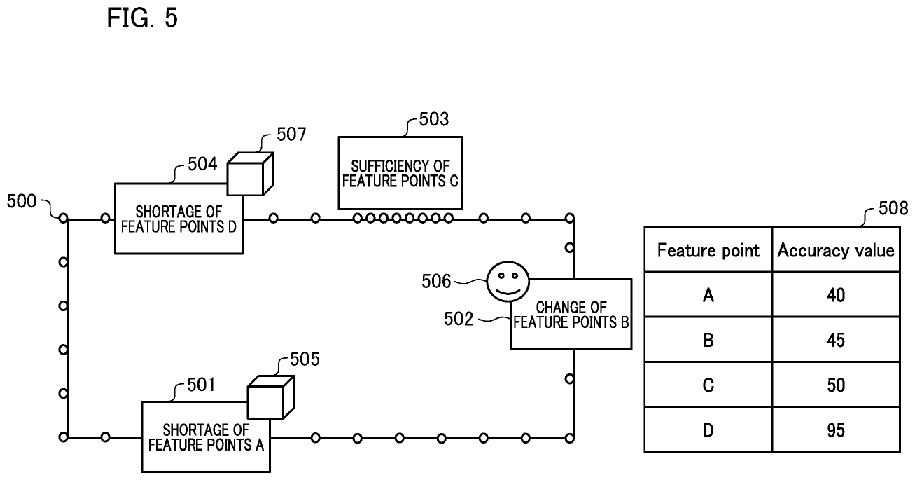

FIG. 5 is a diagram illustrating an example in which a result of image analysis is displayed on a map according to the embodiment of the present invention. In the present embodiment, a window for presenting two-dimensional map information is described, but three-dimensional map information may be presented. Details illustrated in FIG. 5 are displayed on the output device 209. As described above, the input device 206 may serve as an input/output device such as a tablet at that time.

In FIG. 5, an example in which a map 500 stored in the self-position estimating unit 201 is presented is illustrated, but a self-position of an AGV may be combined onto a map on the basis of the self-position of the self-position estimating unit 201. 501 denotes feature point shortage at a feature point A, and 505 denotes an icon of a cardboard box displayed due to detection of a cardboard box as a result of detection of an object.

Similarly, 504 denotes feature point shortage at a feature point D, and 507 denotes an icon of a cardboard box displayed due to detection of a cardboard box as a result of detection of an object. 502 denotes change of a predetermined number of feature points at a feature point B, and 506 denotes an icon displayed due to detection of a person as a result of detection of an object. 503 denotes feature point sufficiency at a feature point C.

That is, when accuracy of self-position estimation is lower than the predetermined range such as 501, 502, and 504, the notification unit notifies of a factor thereof (such as shortage of the number of feature points or change in the number of feature points) on the basis of an object detected by the image analyzing unit.

The notification unit may notify of a factor of a decrease in accuracy of self-position estimation such as a low likelihood of feature points. In 501, 502, or 504, a countermeasure such as “please move . . . ” may be displayed as a message.

508 is an accuracy value list and shows accuracy values of the self-position at the feature points A to D. In this way, by presenting a map, a position of an AGV, a detection result of an object, and a route on the map prepared by the SLAM, a user can easily ascertain a status of self-position accuracy, a factor thereof, a countermeasure, and the like. The notification unit may notify of a value associated with accuracy of self-position estimation as shown in the accuracy value list 508.

In the present embodiment, the movable apparatus is not limited to an automated guided vehicle (AGV). For example, the movable apparatus may be an autonomously driven vehicle or an autonomous mobile robot, and movement control described above in the present embodiment may be applied thereto.

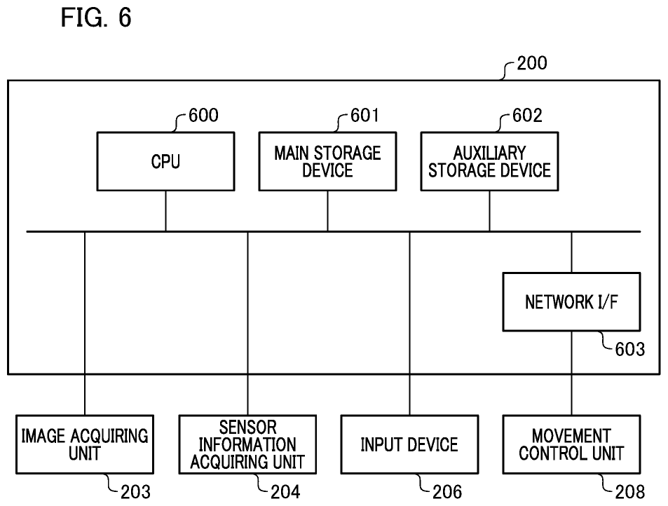

FIG. 6 is a block diagram illustrating an example of a hardware configuration of the information processing device according to the embodiment of the present invention. As illustrated in FIG. 6, the information processing device 200 includes a CPU 600, a main storage device 601, an auxiliary storage device 602, and a network I/F 603.

The image acquiring unit 203, the sensor information acquiring unit 204, the input device 206, and the movement control unit 208 are connected to, for example, a bus of the information processing device.

The CPU 600 of the information processing device 200 performs processes using a computer program or data stored in the main storage device 601. Accordingly, the CPU 600 controls the whole operation of the information processing device 200 and performs or controls the aforementioned processes which are performed by the information processing device.

For example, the CPU 600 realizes the operations of the flowchart illustrated in FIG. 3 by performing processes using a computer program or data stored in the main storage device 601.

The main storage device 601 is a storage device such as a random access memory (RAM). The main storage device 601 stores a computer program or data loaded from the auxiliary storage device 602. The main storage device 601 includes areas for storing captured images acquired by the image acquiring unit 203 and various types of data received from the movement control unit 208 via the network I/F 603.

The main storage device 601 includes a work area used for the CPU 600 to perform various processes. In this way, the main storage device 601 can appropriately provide various areas.

The auxiliary storage device 602 is a large-capacity information storage device such as a hard disk drive (HDD), a read only memory (ROM), or a solid state drive (SSD).

An operating system (OS) or a computer program or data for allowing the CPU 600 to perform or control the processes described above to be performed by the information processing device is stored in the auxiliary storage device 602. Data (for example, imaging parameters) received from the movement control unit 208 or the like via the network I/F 603 is also stored in the auxiliary storage device 602.

The computer programs or data stored in the auxiliary storage device 602 is appropriately loaded to the main storage device 601 under the control of the CPU 600 and processed by the CPU 600. The network I/F 603 is an interface used for the information processing device 200 to communicate with the movement control unit 208 via a network.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing device through a network or various storage media. Then, a computer (or a CPU, an MPU, or the like) of the information processing device may be configured to read and execute the program. In such a case, the program and the storage medium storing the program configure the present invention.

The present invention may be realized, for example, using at least one processor or circuit configured to perform functions of the embodiments explained above. The functions may be performed in a distributed manner by a plurality of processors.

This application claims the benefit of Japanese Patent Application No. 2022-191430, filed on Nov. 30, 2022, which is hereby incorporated by reference herein in its entirety.

What is claimed is:

1. An information processing device comprising at least one processor or circuit configured to function as:
a self-position estimating unit configured to estimate a self-position on the basis of an image;
an accuracy determining unit configured to determine accuracy in estimation of the self-position;
an image analyzing unit configured to detect an object from the image; and
a notification unit configured to notify of information on the object detected by the image analyzing unit in a case in which the accuracy is outside of a predetermined range.

2. The information processing device according to claim 1, wherein the notification unit notifies of a factor on the basis of the object detected by the image analyzing unit in a case in which the accuracy is lower than the predetermined range.

3. The information processing device according to claim 1, wherein the notification unit notifies of a countermeasure for increasing the accuracy on the basis of the object detected by the image analyzing unit in a case in which the accuracy is lower than the predetermined range.

4. The information processing device according to claim 1, wherein the notification unit performs notification in a case in which the accuracy is higher than the predetermined range.

5. The information processing device according to claim 1, wherein the notification unit notifies of a value associated with the accuracy.

6. The information processing device according to claim 1, wherein the at least one processor or circuit is further configured to function as a storage unit configured to store notification details correlated with the object.

7. The information processing device according to claim 1, wherein the self-position estimating unit generates a map on the basis of the image.

8. The information processing device according to claim 1, wherein the notification unit determines that the accuracy is lower than the predetermined range in a case in which the number of feature points in estimation of the self-position is equal to or less than a predetermined number.

9. The information processing device according to claim 1, wherein the notification unit determines that the accuracy is lower than the predetermined range in a case in which a likelihood of feature points in estimation of the self-position is equal to or less than a predetermined threshold value.

10. An information processing method comprising:
estimating a self-position on the basis of an image;
determining accuracy in estimation of the self-position;
detecting an object from the image; and
notifying of information on the object detected in the detecting of an object in a case in which the accuracy is outside of a predetermined range.

11. A non-transitory computer-readable storage medium configured to store a computer program comprising instructions for executing following processes:
estimating a self-position on the basis of an image;
determining accuracy in estimation of the self-position;
detecting an object from the image; and
notifying of information on the object detected in the detecting of an object in a case in which the accuracy is outside of a predetermined range.
